(19) United States
(12) Patent Application Publication
(10) Pub. No.: US 2018/0041629 A1
(43) Pub. Date: Feb. 8, 2018

(54) INFORMATION PROCESSING DEVICE AND LOCK CONTROL METHOD

(71) Applicant: FUJITSU LIMITED, Kawasaki-shi (JP)

(72) Inventors: Eiichi Matsuzaki, Koto (JP); Taiki Nagayama, Kawasaki (JP)

(73) Assignee: FUJITSU LIMITED, Kawasaki-shi (JP)

(21) Appl. No.: 15/635,545

(22) Filed: Jun. 28, 2017

(30) Foreign Application Priority Data
Aug. 3, 2016 (JP) 2016-152812

(51) Int. Cl. H04M 1/725; H04W 8/00

(52) U.S. Cl. CPC H04M 1/72577; H04W 8/005; H04W 88/02

(57) ABSTRACT

An information processing device includes a memory and a processor coupled to the memory. The processor is configured to establish a locked state of the information processing device. The processor is configured to search for a first device among information processing devices, the first device being located in a predetermined area from the information processing device. The first device is operated by a user operating the information processing device. The processor is configured to inhibit the establishment of the locked state of the information processing device when the first device is found.

### CROSS-REFERENCE TO RELATED APPLICATION

This application is based upon and claims the benefit of priority of the prior Japanese Patent Application No. 2016-152812, filed on Aug. 3, 2016, the entire contents of which are incorporated herein by reference.

### FIELD

The embodiment discussed herein is related to an information processing device and a lock control method.

### BACKGROUND

In late years, it is not uncommon to see a single user owning multiple terminal devices such a personal computer (PC), a tablet, a smartphone, and so forth.

These terminal devices are often equipped with a lock function for the purpose of security improvement. When a terminal device is not operated for a preset period, the lock function is designed to fixedly display an input screen for unlocking, for example, and to reject operations other than an unlocking operation. A preset specific input operation using password input, biometric authentication, or the like is to be performed in order to release a locked state.

Related techniques are disclosed in, for example, Japanese Laid-open Patent Publication No. 2006-102948, Japanese Laid-open Patent Publication No. 2008-226210, Japanese Laid-open Patent Publication No. 2008-193166, Japanese Laid-open Patent Publication No. 2009-15501, and Japanese Laid-open Patent Publication No. 2005-99515.

A possible example of allowing a single user to employ multiple terminal devices as described above is a case in which a first terminal device is used to display an electronic document such as a documented work instruction while a second terminal device is operated to conduct work and the like. In this method of use, the first terminal device displaying the documented work instruction is kept unoperated during the operation using the second terminal device. This may lead to a situation in which the first terminal device activates a lock function every time there is a lapse of a certain period, and a worker has to perform an input operation for unlocking in each case. As a consequence, this case may result in reduced work efficiency.

Here, a possible option for cutting out cumbersome input operations for unlocking is to set the terminal device displaying the electronic document not to make a transition to a locked state even when the terminal device is left unoperated for a long period. However, the setting not to make a transition to a locked state even when the terminal device is left unoperated for a long period as described above brings about a longer period for allowing anyone to operate the terminal device, and a security level thereof is decreased as a consequence.

### SUMMARY

According to an aspect of the present invention, provided is an information processing device including a memory and a processor coupled to the memory. The processor is configured to establish a locked state of the information processing device. The processor is configured to search for a first device among information processing devices, the first device being located in a predetermined area from the information processing device. The first device is operated by a user operating the information processing device. The processor is configured to inhibit the establishment of the locked state of the information processing device when the first device is found.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a computer system according to an embodiment;

FIG. 2 is a diagram illustrating an exemplary functional configuration of a lock control unit in the computer system according to the embodiment;

FIG. 3 is a diagram illustrating device information in the computer system according to the embodiment;

FIG. 4 is a diagram illustrating connection state management information in the computer system according to the embodiment;

FIG. 5 is a diagram illustrating in-operation state management information in the computer system according to the embodiment;

FIG. 6 is a diagram illustrating processing by a lock inhibition control unit in the computer system according to the embodiment;

FIG. 7 is a diagram illustrating processing by lock inhibition control units in the computer system according to the embodiment;

FIG. 8 is a flowchart illustrating a method of searching for a nearby information processing device performed by a search unit in the computer system according to the embodiment; and

FIG. 9 is a flowchart illustrating a log-on control method at a start-up of an information processing device in the computer system according to the embodiment.

### DESCRIPTION OF EMBODIMENT

An embodiment of an information processing device and a lock control method will be described below with reference to the drawings.

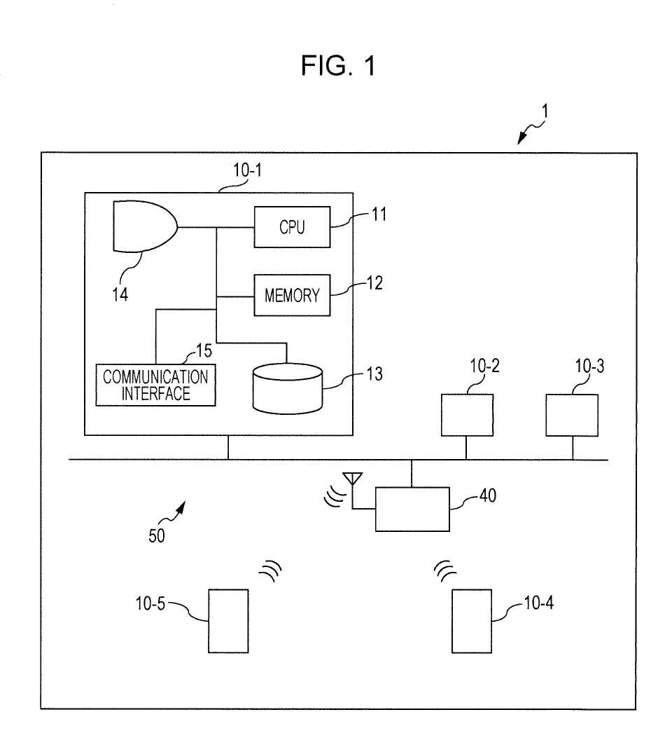

FIG. 1 is a diagram illustrating an exemplary configuration of a computer system 1 according to the embodiment.

The computer system 1 illustrated in FIG. 1 includes multiple (five in the example illustrated in FIG. 1) information processing devices 10-1 to 10-5, and is installed in a home of a user, for instance.

The information processing devices 10-1 to 10-5 are communicably coupled to one another through a network 50.

For example, the information processing devices 10-1 to 10-3 are wire-coupled to a not-illustrated router through local area network (LAN) cables, respectively.

The network 50 is provided with a wireless router 40 and the information processing devices 10-4 and 10-5 are wirelessly coupled to the network 50 through the wireless router 40 serving as a wireless access point (AP).

The information processing devices 10-1 to 10-5 have similar configurations. For the sake of convenience, FIG. 1 depicts a hardware configuration of only the information processing device 10-1, and illustration of hardware configurations of the information processing devices 10-2 to 10-5 is omitted therein.

Hereinafter, particular ones of the information processing devices may be referred to as the information processing devices 10-1 to 10-5, and an arbitrary one of the information processing devices may be referred to as an information processing device 10. In addition, an information processing device 10 may also be referred to as a terminal 10 in the following description.

As illustrated in FIG. 1, each information processing device 10 includes a central processing unit (CPU) 11, a memory 12, a storage device 13, a display unit 14, and a communication interface 15.

The storage device 13 is a storage device configured to store various data, and is a hard disk drive (HDD), a solid state drive (SSD), a storage class memory (SCM), and the like.

The memory 12 is a storage memory including a read-only memory (ROM) and a random access memory (RAM).

A software program (a lock control program) for lock control, data used in association with the program, and the like are written in the ROM of the memory 12. The software program stored in the memory 12 is appropriately read and executed by the CPU 11. The RAM of the memory 12 is used as a temporary storage memory or as a working memory.

The communication interface 15 provides a communication function to perform communication with other information processing devices 10 and the like. The communication interface 15 is a LAN card or a wireless LAN communication module, for instance. The communication interface 15 also includes a wireless communication module that employs Bluetooth (registered trademark) and the like.

In the example illustrated in FIG. 1, each of the information processing devices 10-1 to 10-3 wire-coupled to the network 50 is provided with a LAN card as the communication interface 15. Meanwhile, each of the information processing devices 10-4 and 10-5 wirelessly coupled to the wireless router 40 is provided with a wireless LAN module as the communication interface 15.

The CPU 11 is a processing unit that performs various control and arithmetic operations. The CPU 11 executes an operating system (OS) and software stored in the memory 12 and the like, thereby realizing various functions. A multiprocessor may be constructed by using multiple CPUs 11. Any one of a micro processing unit (MPU), a digital signal processor (DSP), an application specific integrated circuit (ASIC), a programmable logic device (PLD), and a field programmable gate array (FPGA) may be provided instead of the CPU. Two or more elements of the CPU, the MPU, the DSP, the ASIC, the PLD, and the FPGA may be used in combination.

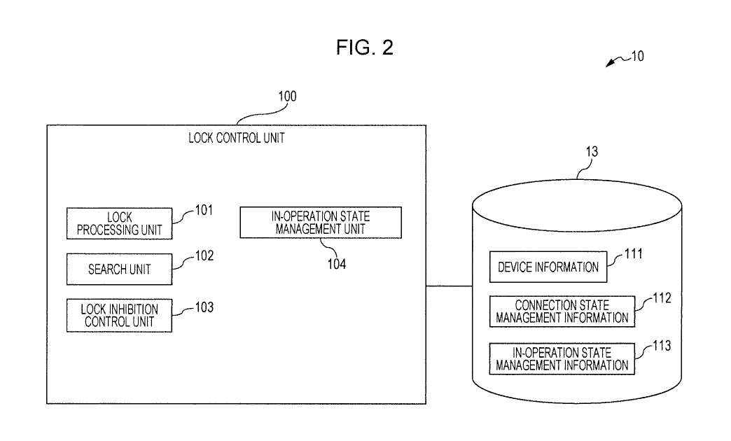

The CPU 11 of the information processing device 10 executes the lock control program to function as a lock control unit 100 (see FIG. 2) to be described later.

The program (the lock control program) for realizing the function as the lock control unit 100 is provided in the form recorded in any of computer-readable recording media including a flexible disc, a compact disc (CD) such as a CD-ROM, a CD-R, and a CD-RW, a digital versatile disc (DVD) such as a DVD-ROM, a DVD-RAM, a DVD-R, a DVD+R, a DVD-RW, a DVD+RW, and an HD DVD, a Blu-ray disc, a magnetic disc, an optical disc, a magneto-optical disc, and the like. The CPU 11 reads the program out of such a recording medium, and then transfers and stores the program into an internal storage device or an external storage device to use the program. Alternatively, the program may be recorded in a storage device (a recording medium) such as a magnetic disc, an optical disc, and a magneto-optical disc in advance, and may be provided from the storage device to a computer through a communication path.

To realize the function as the lock control unit 100, the program stored in the internal storage device (which is the RAM or the ROM in the memory 12 in this embodiment) is executed by a microprocessor (which is the CPU 11 in this embodiment) of the computer. The computer may read and execute the program recorded in the recording medium.

FIG. 2 is a diagram illustrating a functional configuration of the lock control unit 100 in the computer system 1 according to the embodiment.

In the information processing device 10, the lock control unit 100 controls the lock function of the information processing device 10.

As illustrated in FIG. 2, the lock control unit 100 is equipped with functions as a lock processing unit 101, a search unit 102, a lock inhibition control unit 103, and an in-operation state management unit 104.

The search unit 102 searches for another information processing device 10 located near the own information processing device 10 which includes the search unit 102. Here, a location near the own information processing device 10 is preferably a location at such a distance that renders the other information processing device 10 directly visible from the location of the own information processing device 10, for example.

For instance, when the multiple information processing devices 10 are used at such distances that render the information processing devices 10 visible from one another at home or the like, then the information processing devices 10 are thought to be used by the same person.

In this case, if one (a first information processing device 10) of the information processing devices 10 is accepting an operation input (being operated) by a user and another one (a second information processing device 10) of the information processing devices 10 is also being operated by the same user, then these information processing devices 10 are thought to be used in parallel by the user. In other words, the second information processing device 10 is thought to have no security problem while the first information processing device 10 is being operated even if the second information processing device 10 is not locked.

Accordingly, in the computer system 1, the search unit 102 of a certain one of the information processing device 10 searches for another information processing device 10 located in a predetermined area around the one of the information processing devices 10. The one of the information processing devices 10, which includes the search unit 102, may be referred to as an own information processing device 10.

For example, the search unit 102 determines the presence of another information processing device 10 through the network 50 by issuing (outputting) a network management command (an information collection command) of the OS or by using an application programming interface (API). Such check of presence of the information processing device 10 on the network 50 may be realized by using various known methods and detailed description thereof will be omitted.

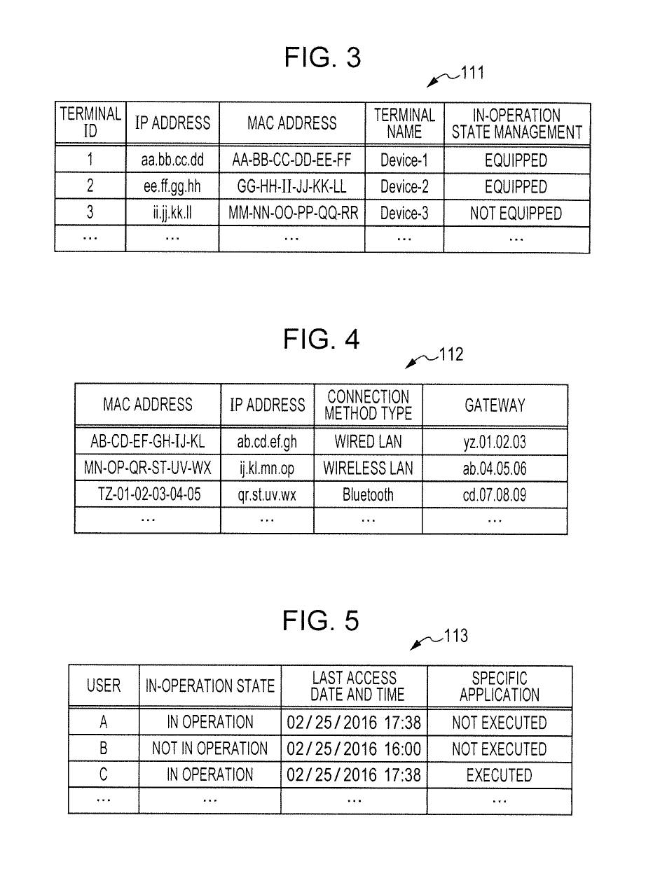

The search unit 102 may collect device information 111 as illustrated in FIG. 3 by checking the presence of the information processing device 10 on the network 50 as described above.

FIG. 3 is a diagram illustrating the device information 111 in the computer system 1 according to the embodiment.

The device information 111 is information on the respective information processing devices 10 included in the computer system 1. The device information 111 illustrated in FIG. 3 includes the following fields of terminal identification (ID), Internet protocol (IP) address, media access control (MAC) address, terminal name, and in-operation state management.

Note that the in-operation state management field indicates whether or not each information processing device 10 is equipped with a function as the in-operation state management unit 104 to be described later. When “equipped” is registered in the in-operation state management field for an information processing device 10, it indicates that the information processing device 10 is equipped with the function as the in-operation state management unit 104. On the other hand, when “not equipped” is registered in the in-operation state management field for an information processing device 10, it indicates that the information processing device 10 is not equipped with the function as the in-operation state management unit 104.

For example, the in-operation state management unit 104 to be described later exchanges in-operation state information with other information processing devices 10 through the network 50 at start-up of the own information processing device 10 or each time after a lapse of a predetermined period. Then, “equipped” is registered in the in-operation state management field of the information processing device 10 which successfully transmits and receives the in-operation state information.

The search unit 102 stores collected pieces of information on the respective information processing devices 10 in the storage device 13 and the like as the device information 111.

Each information processing device 10 is equipped with functions to acquire connection state management information 112 for managing connection states of the respective information processing devices 10 included in the computer system 1, and to store the acquired information in the storage device 13 and the like.

FIG. 4 is a diagram illustrating the connection state management information 112 in the computer system 1 according to the embodiment.

The connection state management information 112 illustrated in FIG. 4 includes the following fields of MAC address, IP address, connection method type, and gateway.

In the example illustrated in FIG. 4, any one of “wired LAN”, “wireless LAN”, and “Bluetooth” is set to the connection method type field. The gateway field represents an address (a gateway address) of a gateway used for access to a device identified by the MAC address.

Collection of a variety of information to be registered in the connection state management information 112 may be realized by using various known methods and specific description thereof will be omitted.

Various pieces of information to be registered in the connection state management information 112 may be associated with one another by using a plug and play function of the OS or by using network management information. Alternatively, a database may be used for the information association.

The search unit 102 determines whether or not each of the information processing devices 10 registered in the device information 111 is located near the own information processing device 10. In the following, each information processing device 10 subjected to the determination by the search unit 102 as to whether or not the relevant information processing device 10 is located near the own information processing device 10 may be referred to as a determination target information processing device 10.

The search unit 102 selects each of the information processing devices 10 registered in the device information 111 as the determination target information processing device 10, and determines whether or not the determination target information processing device 10 is located near the own information processing device 10, based on a connection method between the determination target information processing device 10 and the own information processing device 10.

A description will be given below of the method of determination by the search unit 102 as to whether or not the determination target information processing device 10 is located near the own information processing device 10, that is, whether or not the determination target information processing device 10 is located in the predetermined area around the own information processing device 10.

When the own information processing device 10 is wirelessly coupled to the determination target information processing device 10, the search unit 102 determines that the determination target information processing device 10 is located near the own information processing device 10 if any one of the following conditions (a1) to (a3) is met.

(a1) If the determination target information processing device 10 and the own information processing device 10 are coupled to the same wireless AP, the search unit 102 determines that the determination target information processing device 10 is located near the own information processing device 10.

The determination as to whether or not the access point is the same may be achieved by using the IP address, the MAC address, and the like of the gateway serving as the connection destination (see FIG. 4).

(a2) If the determination target information processing device 10 and the own information processing device 10 are coupled to each other through Wi-Fi Direct (registered trademark), which is one of short-distance wireless connections, the search unit 102 determines that the determination target information processing device 10 is located near the own information processing device 10.

Whether or not the information processing devices 10 are coupled through Wi-Fi Direct may be checked by using a network management function of the OS.

(a3) If the determination target information processing device 10 and the own information processing device 10 are coupled to each other through Bluetooth, which is one of short-distance wireless connections, the search unit 102 determines that the determination target information processing device 10 is located near the own information processing device 10.

Whether or not the information processing devices 10 are coupled through Bluetooth may be checked by referring to the connection method type associated with the MAC address in the above-described connection state management information 112 (see FIG. 4), for example.

Note that even when the determination target information processing device 10 is wirelessly coupled to the own information processing device 10, the search unit 102 determines that the determination target information processing device 10 is not located near the own information processing device 10 if none of the above-described conditions (a1) to (a3) is met.

When the own information processing device 10 is wire-coupled to the determination target information processing device 10, the search unit 102 determines that the determination target information processing device 10 is located near the own information processing device 10 if any one of the following conditions (b1) and (b2) is met.

(b1) If the determination target information processing device 10 is directly connected to the own information processing device 10 through a cross cable, the search unit 102 determines that the determination target information processing device 10 is located near the own information processing device 10.

The direct connection between the determination target information processing device 10 and the own information processing device 10 may be determined by referring to the IP addresses of the determination target information processing device 10 and the own information processing device 10, or time to live (TTL) values in network communication (IP packet) therebetween, for example.

(b2) If the determination target information processing device 10 and the own information processing device 10 are coupled to the same router (not illustrated), the search unit 102 determines that the determination target information processing device 10 is located near the own information processing device 10.

The determination as to whether or not the information processing devices 10 are coupled to the same router may be achieved by referring to the IP address or the MAC address of the connection destination, the IP address or the MAC address of the gateway, or the like.

Note that even when the determination target information processing device 10 is wire-coupled to the own information processing device 10, the search unit 102 determines that the determination target information processing device 10 is not located near the own information processing device 10 if none of the above-described conditions (b1) and (b2) is met.

As described above, the search unit 102 determines whether or not the determination target information processing device 10 is located near the own information processing device 10 by checking the connection state between the own information processing device 10 and the determination target information processing device 10. Specifically, the search unit 102 reckons a distance between the own information processing device 10 and the determination target information processing device 10 by determining whether or not any of the above-described conditions (a1) to (a3), (b1), and (b2) is met with regard to the connection state between the own information processing device 10 and the determination target information processing device 10.

In other words, the search unit 102 presumes that the determination target information processing device 10 is located in the predetermined area from the own information processing device 10, and the determination target information processing device 10 is therefore located near the own information processing device 10 when any one of the above-described conditions (a1) to (a3), (b1), and (b2) is met.

By checking the connection state between the own information processing device 10 and the determination target information processing device 10, the search unit 102 may determine whether or not the determination target information processing device 10 is located in the predetermined area from the own information processing device 10, without being provided with a distance measurement device.

In the following, another information processing device 10 determined by the search unit 102 as being located in the predetermined area from the own information processing device 10 may be referred to as a neighboring information processing device 10.

The in-operation state management unit 104 manages operations performed on the own information processing device 10. The in-operation state management unit 104 manages information on the operations performed on the own information processing device 10 by using in-operation state management information 113.

FIG. 5 is a diagram illustrating the in-operation state management information 113 in the computer system 1 according to the embodiment.

The in-operation state management information 113 illustrated in FIG. 5 includes the following fields of user, in-operation state, last access date and time, and specific application.

Specifically, the in-operation state management information 113 manages the in-operation state, the last access date and time, and the specific application for each of users (log-on accounts) registered in the own information processing device 10. The last access date and time indicates the date and time when the latest operation is detected.

The specific application field indicates whether or not a prescribed specific application program (a specific application) is executed.

In the computer system 1, the user is determined to be performing an operation while the specific application program (the specific application) is being executed. In other words, even in the state where an input operation or the like by the user (a log-on user) does not take place, the log-on user is presumed to be performing an operation when the specific application is being executed.

The in-operation state field indicates whether or not the user is performing an operation. When the user is performing an operation, “in operation” is registered in the in-operation state field. When the user is not performing an operation, “not in operation” is registered in the in-operation state field.

The in-operation state management unit 104 determines that the own information processing device 10 is being operated if any one of the following conditions (c1) to (c3) is met.

(c1) The own information processing device 10 is determined to be being operated when the own information processing device 10 is not locked.

(c2) The own information processing device 10 is determined to be being operated during a predetermined period after an input operation with an input device (not illustrated) such as a keyboard, a mouse, and a touch panel.

(c3) The own information processing device 10 is determined to be being operated while the specific application program (the specific application) is being executed.

In answer to an inquiry about the in-operation state from the lock inhibition control unit 103 of another information processing device 10 to be described later, the in-operation state management unit 104 sends a response containing information on the in-operation state.

By managing the in-operation state management information 113 as described above, the in-operation state management unit 104 may grasp whether or not the user logging on the own information processing device 10 is operating the own information processing device 10.

It may be determined that the user is in a state of logged-on only during a period when the user account is actually in the state of logged-on. When the user account had logged on and then logged off, it may be determined that the user is still in the state of logged-on until a predetermined period elapses.

Upon receipt of a request inquiring about the in-operation state, which is sent from the lock inhibition control unit 103 of another information processing device 10 to the own information processing device 10, the in-operation state management unit 104 may send a response containing the in-operation state of the own information processing device 10.

Here, in answer to the inquiry about the in-operation state from the lock inhibition control unit 103 of the other information processing device 10, the in-operation state management unit 104 may send a response containing the in-operation states concerning all the users managed in the in-operation state management information 113, or send a response containing only the in-operation state concerning the particular user involved in the inquiry.

Upon receipt of the request inquiring about the in-operation state, which is sent from the lock inhibition control unit 103 of the other information processing device 10, the in-operation state management unit 104 sends a response containing the in-operation state management information 113 indicating the in-operation state of the own information processing device 10.

The settings concerning the above-described conditions (c1) to (c3) are stored in the storage device 13 of the own information processing device 10, for example.

When the own information processing device 10 satisfies a prescribed condition (a locking condition), the lock processing unit 101 establishes a locked state of the own information processing device 10. In the locked state, the lock processing unit 101 fixedly displays an input screen used for inputting a password for unlocking, for example, and rejects operations other than an unlocking operation.

The locking condition is defined as absence of an input operation for a predetermined period (such as 1 minute), for example. Accordingly, the lock processing unit 101 does not establish the locked state when the own information processing device 10 is being operated. Since the own information processing device 10 is considered to be being operated if any one of the above-described conditions (c1) to (c3) is met, the lock processing unit 101 does not establish the locked state in this case. In other words, the locking condition remains unsatisfied as long as the own information processing device 10 is being operated.

Note that in the computer system 1, information indicating the locking condition (such as information to define a non-operation period before transition to the locked state) is stored in the storage device 13 of each information processing device 10.

The lock inhibition control unit 103 performs control such that the lock processing unit 101 is inhibited from causing the own information processing device 10 to make a transition to the locked state.

When another information processing device 10 is located in the predetermined area around the own information processing device 10, the lock inhibition control unit 103 inhibits the lock processing unit 101 from causing the own information processing device 10 to make a transition to the locked state if the other information processing device 10 is being operated by the same user as the one operating the own information processing device 10.

In this regard, when the own information processing device 10 satisfies the locking condition, the lock inhibition control unit 103 causes the search unit 102 to search for another information processing device 10 located in the predetermined area around the own information processing device 10.

When the search unit 102 detects another information processing device 10 located in the predetermined area around the own information processing device 10, the lock inhibition control unit 103 checks with the other information processing device 10 (the neighboring information processing device 10) whether or not the neighboring information processing device 10 is being operated by the same user as the one operating the own information processing device 10.

The lock inhibition control unit 103 sends the neighboring information processing device 10 a user ID and the like on the user logging on the own information processing device 10, for example, thereby inquiring whether or not the log-on user is operating the neighboring information processing device 10.

The lock inhibition control unit 103 may inquire the neighboring information processing device 10 about a user who is operating the neighboring information processing device 10.

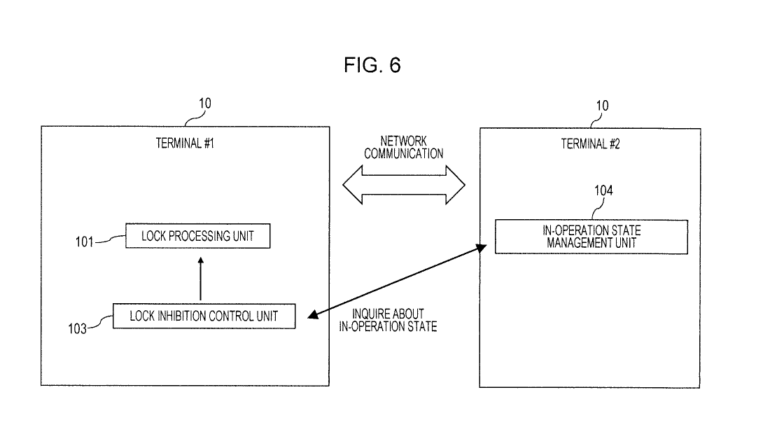

FIG. 6 is a diagram illustrating processing by the lock inhibition control unit 103 in the computer system 1 according to the embodiment.

FIG. 6 illustrates an example in which the lock inhibition control unit 103 of a terminal #1 inquires with the in-operation state management unit 104 of a terminal #2 about the in-operation state of the terminal #2. For instance, the lock inhibition control unit 103 of the terminal #1 sends the user ID and the like on the user logging on the own information processing device 10 to the in-operation state management unit 104 of the terminal #2, for example, thereby inquiring whether or not the log-on user is operating the terminal #2.

The lock inhibition control unit 103 receives the in-operation state responded from the in-operation state management unit 104 of the neighboring information processing device 10. Then, the lock inhibition control unit 103 inhibits the lock processing unit 101 from causing the own information processing device 10 to make a transition to the locked state when the responded in-operation state indicates that the user logging on the own information processing device 10 is operating the neighboring information processing device 10.

As illustrated in FIG. 6, the lock inhibition control unit 103 may inquire about the in-operation state and receiving the response by using one-to-one communication with the neighboring information processing device 10, for example.

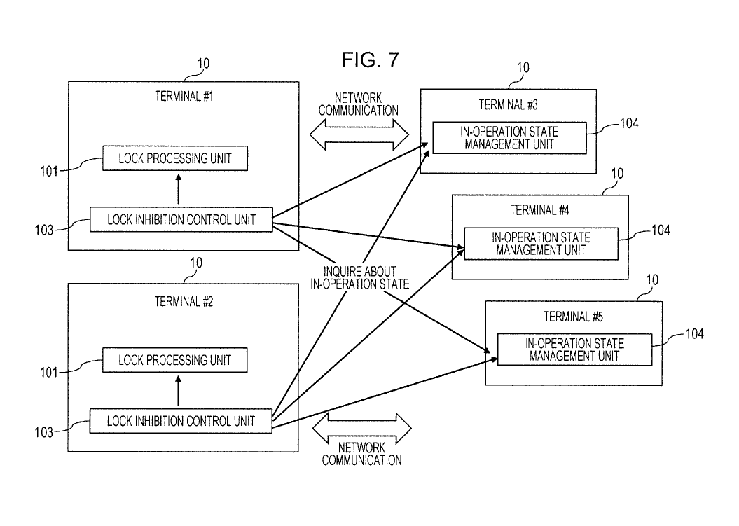

FIG. 7 is a diagram illustrating processing by the lock inhibition control units 103 in the computer system 1 according to the embodiment. FIG. 7 illustrates an example in which the respective lock inhibition control units 103 of multiple (two in the example illustrated in FIG. 7) terminals #1 and #2 inquire with the respective in-operation state management units 104 of multiple (three in the example illustrated in FIG. 7) terminals #3 to #5 about the in-operation states of the respective terminals 10.

Each lock inhibition control unit 103 may also inquire with each information processing device 10 about in-operation information by conducting broadcast communication with the other information processing devices 10, for instance.

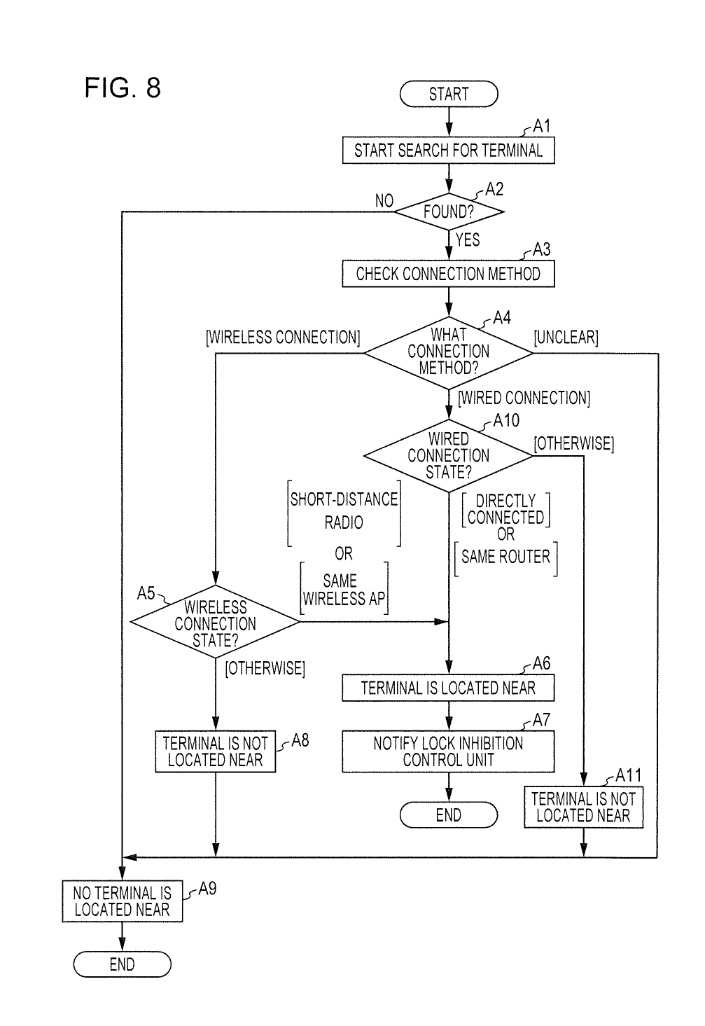

A method of searching for a nearby information processing device 10 performed by the search unit 102 in the computer system 1 according to the embodiment of the above-described configuration will be described with reference to a flowchart illustrated in FIG. 8.

In A1, the search unit 102 starts searching for a terminal 10 coupled through the network 50.

The search unit 102 searches for another terminal 10, which is coupled to the own information processing device 10 through the network 50, by issuing an information collection command for collecting information to other information processing devices 10 through the network 50, for example.

The search unit 102 checks whether or not another terminal 10 is found as a consequence of the search (A2), and proceeds to A3 when another terminal 10 is found (YES in A2).

In A3, the search unit 102 checks a connection method between the own information processing device 10 and the found terminal 10, that is, the determination target information processing device 10.

As a result of checking the connection method (A4), the search unit 102 proceeds to A5 when the own information processing device 10 is wirelessly coupled to the determination target information processing device 10 ([wireless connection] in A4).

In A5, the search unit 102 checks the wireless connection state between the own information processing device 10 and the determination target information processing device 10 by referring to the connection state management information 112 (see FIG. 4), for example.

As a result of the check, the search unit 102 proceeds to A6 when the own information processing device 10 and the determination target information processing device 10 are coupled to each other by short-distance wireless connection ([short-distance radio] in A5) or are coupled to the same wireless AP ([same wireless AP] in A5).

In A6, the search unit 102 determines that the determination target information processing device 10 is located near the own information processing device 10.

Thus, another terminal 10 located near the own information processing device 10 is found by the search unit 102. Hence, the search unit 102 notifies the lock inhibition control unit 103 of the other terminal 10 as the neighboring information processing device 10 in A7. Thereafter, the processing is terminated.

As a result of the check in A5, the search unit 102 proceeds to A8 when the own information processing device 10 and the determination target information processing device 10 are neither coupled to each other by short-distance wireless connection nor coupled to the same wireless AP ([otherwise] in A5).

In A8, the search unit 102 determines that the determination target information processing device 10 is not located near the own information processing device 10, and then proceeds to A9.

In A9, the search unit 102 determines that there is no other terminal 10 located near the own information processing device 10, and terminates the processing.

As a result of the check in A4, the search unit 102 proceeds to A10 when the own information processing device 10 is wire-coupled to the determination target information processing device 10 ([wired connection] in A4).

In A10, the search unit 102 checks the wired connection state between the own information processing device 10 and the different terminal 10 by referring to the connection state management information 112, for example.

As a result of the check, the search unit 102 proceeds to A6 when the own information processing device 10 and the determination target information processing device 10 are directly connected to each other ([directly connected] in A10) or are coupled to the same router ([same router] in A10).

As a result of the check in A10, the search unit 102 proceeds to A11 when the own information processing device 10 and the determination target information processing device 10 are neither directly connected to each other nor coupled to the same router ([otherwise] in A10).

In A11, the search unit 102 determines that the determination target information processing device 10 is not located near the own information processing device 10, and then proceeds to A9.

As a result of the check in A2, the search unit 102 also proceeds to A9 when no other terminal 10 is found (NO in A2).

As a result of the check in A4, the search unit 102 also proceeds to A9 when the connection method between the own information processing device 10 and the determination target information processing device 10 is unclear ([unclear] in A4).

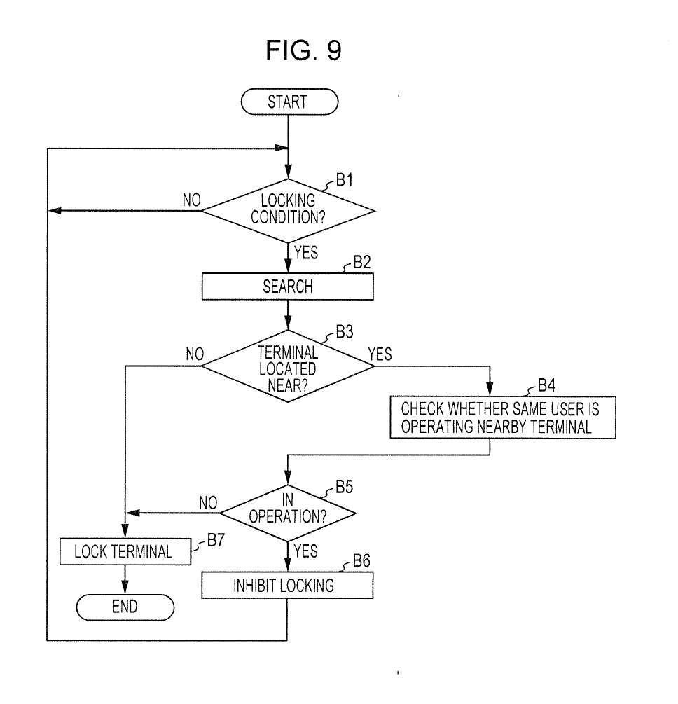

Next, a log-on control method at a start-up of the information processing device 10 in the computer system 1 according to the embodiment will be described with reference to a flowchart illustrated in FIG. 9.

FIG. 9 illustrates a case in which the information processing device 10 (the terminal #1) is shared by multiple users and a user A among the multiple users is using the terminal #1.

In B1, the lock processing unit 101 of the terminal #1 checks whether or not the locking condition is met. Specifically, the lock processing unit 101 checks whether or not the terminal #1 is not being operated (left unoperated) continuously for a predetermined period (such as 1 minute). When the locking condition is not met, (NO in B1), B1 is repeated until the locking condition is met.

The lock processing unit 101 proceeds to B2 when the unoperated period continues for the predetermined period or more and the locking condition is thus met (YES in B1).

In B2, the search unit 102 of the terminal #1 searches for a terminal 10 located near the own information processing device 10 by issuing the information collection command.

Based on information sent from another information processing device 10 in response to the information collection command, the search unit 102 determines whether or not the other information processing device 10 is located in the predetermined area around the own information processing device 10 (B3).

As a result of the determination, the search unit 102 proceeds to B4 when the other information processing device 10 (the terminal #2 in the example illustrated in FIG. 9) is located near the own information processing device 10 (YES in B3). In other words, the terminal #2 is a neighboring information processing device 10.

In B4, the lock inhibition control unit 103 of the terminal #1 sends an inquiry to the terminal #2 to check whether or not the user A is operating the terminal #2.

The in-operation state management unit 104 of the terminal #2 checks whether or not the user A is operating its own information processing device 10 (terminal #2) by referring to the in-operation state management information 113 of the terminal #2. The in-operation state management unit 104 of the terminal #2 sends a result to the terminal #1 as a response.

In B5, based on the response from the terminal #2, the lock inhibition control unit 103 checks whether or not the user A is operating the terminal #2.

As a result of the check, when the user A is operating the terminal #2 (YES in B5), the lock inhibition control unit 103 inhibits the lock processing unit 101 from causing the own information processing device 10 to make a transition of the own information processing device 10 to the locked state (B6). In other words, the terminal #1 is kept unlocked. Thereafter, the processing returns to B1.

As a result of the check in B3, when no other information processing device 10 is located near the own information processing device 10 (the terminal #1) (NO in B3), the lock inhibition control unit 103 does not inhibit the locking by the lock processing unit 101 in B7. In other words, the lock processing unit 101 establishes the locked state of the own information processing device 10 (the terminal #1).

As a result of the check in B5, the lock inhibition control unit 103 also proceeds to B7 when the user A is not operating the terminal #2 (NO in B5). Here, the lock processing unit 101 establishes the locked state of the own information processing device 10 (the terminal #1). Thereafter, the processing is terminated.

As described above, in the computer system 1 according to the embodiment, when another information processing device 10 is located in the predetermined area around the own information processing device 10, the lock inhibition control unit 103 inhibits the lock processing unit 101 from causing the own information processing device 10 to make a transition to the locked state if the other information processing device 10 is being operated by the same user as the one operating the own information processing device 10.

Thus, regarding multiple information processing devices 10 to be operated by the same user, even when one of the information processing devices 10 satisfies the locking condition due to a lapse of a predetermined period, the one information processing device 10 is kept from being locked as long as the user is operating another information processing device 10. Thus, the user may continuously use the one information processing device 10. In this way, the user does not have to perform a cumbersome unlocking operation and operability is improved as a consequence.

For example, in a circumstance (such as at home) where the information processing devices 10 are free from risk of being used by someone else and when the user conducts work and the like by using one information processing device 10 while looking at an electronic document such as a documented work instruction displayed on another one information processing device 10, it is possible to use the other one information processing device 10 for displaying the electronic document without being locked. In other words, the work or the like of the user is not interrupted by the other one information processing device 10 being locked, and work efficiency is thus improved.

In this way, it is possible to maintain device security without the request to relax the locking condition applied to the other one information processing device 10, such as increasing a set value for the predetermined period defined as the locking condition. As a consequence, it is possible to achieve security and convenience at the same time.

Based on the connection method between the determination target information processing device 10 and the own information processing device 10, the search unit 102 determines that the determination target information processing device 10 is located near the own information processing device 10 when any one of the above-described conditions (a1) to (a3), (b1), and (b2) is met.

Specifically, the search unit 102 determines that the determination target information processing device 10 is located in the predetermined area from the own information processing device 10 if any one of the following conditions is met, namely, if the determination target information processing device 10 and the own information processing device 10 are wirelessly coupled to the same AP, if the determination target information processing device 10 is wirelessly coupled to the own information processing device 10 by short-distance wireless connection, if the determination target information processing device 10 is directly wire-connected to the own information processing device 10, and if the determination target information processing device 10 and the own information processing device 10 are wire-coupled to the same router.

Thus, it is possible to determine whether or not another information processing device 10 is located near the own information processing device 10 without providing the information processing device 10 with hardware or the like for measuring the distance from the other information processing device 10.

In the above-described embodiment, the search unit 102 determines whether or not the determination target information processing device 10 is located near the own information processing device 10 by determining whether or not any one of the above-described conditions (a1) to (a3), (b1), and (b2) is met. However, the configuration of the search unit 102 is not limited to the foregoing.

For instance, a router that combines a function as a wireless AP, a function as a wired LAN hub, and a function as a router has been used in recent years. The use of such a router may allow coexistence of a wirelessly coupled information processing device 10 and a wire-coupled information processing device 10 in the same network.

In this regard, when one of the own information processing device 10 and the determination target information processing device 10 is wire-coupled while the other one of the own information processing device 10 and the determination target information processing device 10 is wirelessly coupled, the search unit 102 may determine that the determination target information processing device 10 is located near the own information processing device 10 if the following condition (d1) is met.

(d1) If a gateway to which the determination target information processing device 10 is coupled is the same as a gateway to which the own information processing device 10 is coupled, the search unit 102 determines that the determination target information processing device 10 is located near the own information processing device 10.

The wirelessly coupled information processing device 10 checks the IP address, the MAC address, and the like of the gateway serving as the connection destination by using the method discussed in the condition (a1). The wire-coupled information processing device 10 checks the IP address or the MAC address of the connection destination, the IP address or the MAC address of the gateway, or the like by using the method discussed in the condition (b2). By using these methods, it is possible to determine whether or not the gateways serving as the connection destinations are the same based on the IP addresses, the MAC addresses, and the like.

As described above, the search unit 102 may presume that the determination target information processing device 10 is located in the predetermined area from the own information processing device 10 and thus the determination target information processing device 10 is located near the own information processing device 10 when any one of the above-described conditions (a1) to (a3), (b1), (b2), and (d1) is met.

In the above-described embodiment, the search unit 102 determines that the determination target information processing device 10 is located in the predetermined area from the own information processing device 10 if any one of the following conditions is met, namely, if the determination target information processing device 10 and the own information processing device 10 are wirelessly coupled to the same AP, if the determination target information processing device 10 is wirelessly coupled to the own information processing device 10 by short-distance wireless connection, if the determination target information processing device 10 is directly wire-connected to the own information processing device 10, and if the determination target information processing device 10 and the own information processing device 10 are wire-coupled to the same router. However, the configuration of the search unit 102 is not limited to the foregoing.

For instance, the information processing device 10 may be provided with a not-illustrated distance measurement device, and may determine whether or not the determination target information processing device 10 is located in the predetermined area from the own information processing device 10 by measuring the distance to the determination target information processing device 10 using the distance measurement device.

In the above-described embodiment, the in-operation state management unit 104 determines whether or not the own information processing device 10 is being operated by the user by determining whether or not any of the above-described conditions (c1) to (c3) is met. However, the configuration of the in-operation state management unit 104 is not limited to the foregoing.

For instance, conditions other than the conditions (c1) to (c3) may be used for determining whether or not the own information processing device 10 is being operated by the user, or two or more of these conditions may be used in combination for the determination. Thus, the determination may be made by applying appropriate modifications.

The above-described embodiment depicts the example in which the information indicating the locking condition is stored in each information processing device 10. However, the configuration of the information processing device 10 is not limited to the foregoing.

The information indicating the locking condition may be provided to the own information processing device 10 or to another information processing device 10. Alternatively, the computer system 1 may include a not-illustrated management server, and the management server may manage the locking condition. Thus, the management of the information indicating the locking condition may be made by applying appropriate modifications.

By providing the locking condition into the own information processing device 10, the locking condition is kept from being distributed on the network 50. This configuration has an advantage that it is possible to reduce a traffic amount on the network 50. In addition, the processing by the lock processing unit 101 is also kept from being adversely affected by a data transfer delay on the network 50.

By providing the locking condition to the management server, it is possible to consolidate the locking condition, for example.

A person skilled in the art may perform the lock control method and manufacture the information processing device according to the embodiment based on this disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device, comprising:
a memory; and
a processor coupled to the memory and the processor configured to:
establish a locked state of the information processing device;
search for a first device among information processing devices, the first device being located in a predetermined area from the information processing device, the first device being operated by a user operating the information processing device; and
inhibit the establishment of the locked state of the information processing device when the first device is found.

2. The information processing device according to claim 1, wherein
the processor is configured to:
determine whether any one device of the information processing devices is located in the predetermined area from the information processing device by checking a connection state between the information processing device and the one device.

3. The information processing device according to claim 1, wherein
the processor is configured to:
manage information indicating a state of operations by the user; and
notify a second device of the information upon receipt of an inquiry about the state of operations by the user from the second device.

4. A lock control method, comprising:
establishing a locked state of an information processing device by a computer;
searching for a first device among information processing devices, the first device being located in a predetermined area from the information processing device, the first device being operated by a user operating the information processing device; and
inhibiting the establishment of the locked state of the information processing device when the first device is found.

5. The lock control method according to claim 4, the method further comprising:
determining whether any one device of the information processing devices is located in the predetermined area from the information processing device by checking a connection state between the information processing device and the one device.

6. The lock control method according to claim 4, the method further comprising:
managing information indicating a state of operations by the user; and
notifying a second device of the information upon receipt of an inquiry about the state of operations by the user from the second device.

7. A non-transitory computer-readable recording medium having stored therein a program that causes a computer to execute a process, the process comprising:
establishing a locked state of an information processing device;
searching for a first device among information processing devices, the first device being located in a predetermined area from the information processing device, the first device being operated by a user operating the information processing device; and
inhibiting the establishment of the locked state of the information processing device when the first device is found.

8. The non-transitory computer-readable recording medium according to claim 1, the process further comprising:
determining whether any one device of the information processing devices is located in the predetermined area from the information processing device by checking a connection state between the information processing device and the one device.

9. The non-transitory computer-readable recording medium according to claim 1, the process further comprising:
managing information indicating a state of operations by the user; and
notifying a second device of the information upon receipt of an inquiry about the state of operations by the user from the second device.
